(19) United States
(12) Patent Application Publication
(10) Pub. No.: US 2004/0144411 A1
(43) Pub. Date: Jul. 29, 2004

(54) Parkinson's clamp-on hand-operated walker aid

(76) Inventor: Charles Paul Fetheroff, Eastlake, OH (US)

Correspondence Address: Charles Paul Fetheroff, 36155 Sandy Knoll Drive, Eastlake, OH, 44095, US

(21) Appl. No.: 10/350,524

(22) Filed: Jan. 27, 2003

(51) Int. Cl. A61H 3/00

(52) U.S. Cl. 135/67

(57) ABSTRACT

The “Parkinson's Clamp-On Hand-Operated Walker Aid” is a device mounted on a walker (or cane) which is operated by lightly squeezing a hand lever to lower a swing arm using a flexible cable and housing, to be used as a “step-over aid” for a person inflicted with a type of Parkinson's disease who freezes while walking. This “step-over aid” is only applied when required since it is hand operated, and will not inadvertently lower when using the walker (or cane) for stability. The “step-over aid” automatically returns to the upright position when the hand lever is released.

### CROSS-REFERENCE TO RELATED APPLICATIONS

U.S. Pat. No. 6,378,540 Walking assistance device and walking assistance attachment for the device

U.S. Pat. No. 6,055,997 Assistive step-over cane assembly

### BACKGROUND OF THE INVENTION

A person inflicted with a type of Parkinson's disease causes that person's feet to freeze while walking, until some obstacle is placed in front of them, which jumpstarts that person's brain to step over the object and resume the walking sequence. Once the walking continues, the obstacle is no longer needed until such time that the person freezes again.

An obstacle, or mechanical device, that is continually placed in front of that person without intent while that person is walking, can actually freeze that person again or cause that person to loose balance and fall.

This “Parkinson's Clamp-On Hand-Operated Walker Aid” is only applied when required since it is operated by easily squeezing a hand lever, and is safely stored from accidental tripping until such time as it is required again, even if downward pressure is applied to the walker (or cane) while walking. The “step-over aid” will not inadvertently lower when using the walker (or cane) for stability. No bending or crouching is required to lower the “step-over aid” which otherwise could cause that person to loose balance. This device can be installed on either a walker or a cane with identical results, although a walker is preferred because it gives the inflicted person a sense of security and more stability while using the “step-over aid”. Although one “step-over aid” is usually sufficient, with severe cases a walker is capable of containing two of these “step-over aids” if desired, one for the left foot and one for the right foot, with individual hand levers for each.

### SUMMARY OF INVENTION

The “Parkinson's Clamp-On Hand-Operated Walker Aid” is operated by lightly squeezing a hand lever to lower a “step-over aid” using a flexible cable and housing, for a person inflicted with a type of Parkinson's disease who freezes while walking. This “step-over aid” is only applied when required since it is hand operated, and will not inadvertently lower when using the walker (or cane) for stability.

A feature incorporated into the design of the “Parkinson's Clamp-On Hand-Operated Walker Aid” is the installation flexibility. A walker (or cane) with adjustable height is not hindered, because of the clamp-on cable type design. A foldable walker is also not hindered and can be folded easily for traveling.

The “Parkinson's Clamp-On Hand-Operated Walker Aid” is designed to clamp around the outside of the walker (or cane) leg and handle for easy installation on most brands. The only modification is the clamping hole size on three of the pieces here in. This could be sold as an add-on “Parkinson's walker aid kit” possibly using shims to adapt to most walker and cane shaft diameters.

### BRIEF DESCRIPTION OF DRAWINGS

FIG. 1A—Assembly View, lower portion, cane or walker.

FIG. 1B—Operation View, walker, with upper hand lever.

FIG. 1C—Operation View, cane, with upper hand lever.

FIG. 2A—Fabricated Part, Upper Cable Support Clamp.

FIG. 2B—Fabricated Part, Lower Rod Pivot Clamp.

FIG. 2C—Fabricated Part, Cable Clamp and Pivot.

FIG. 2D—Fabricated Part, Swing Arm.

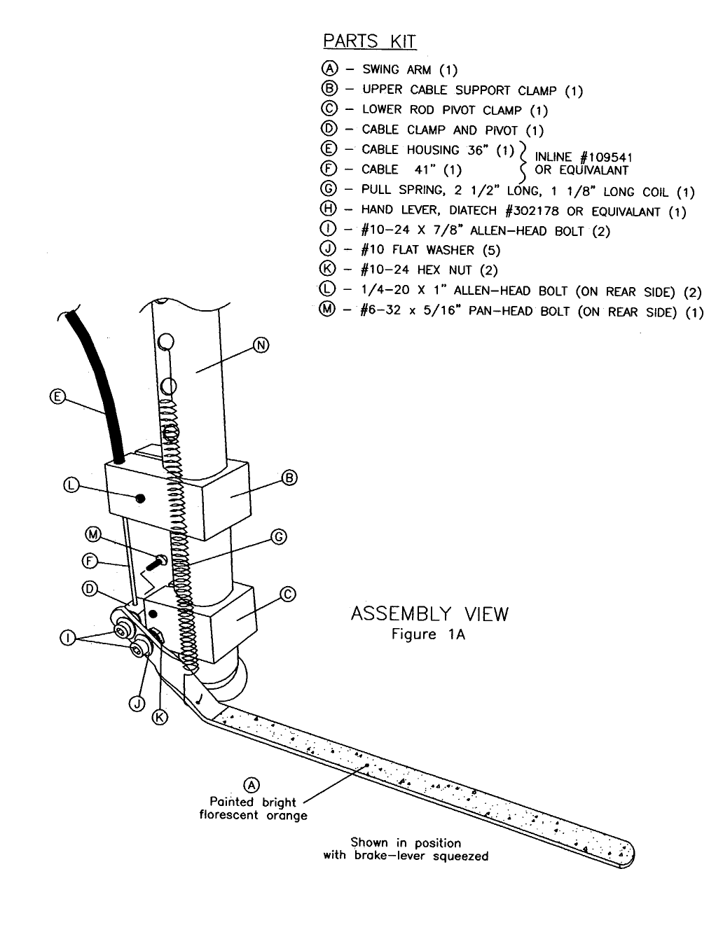

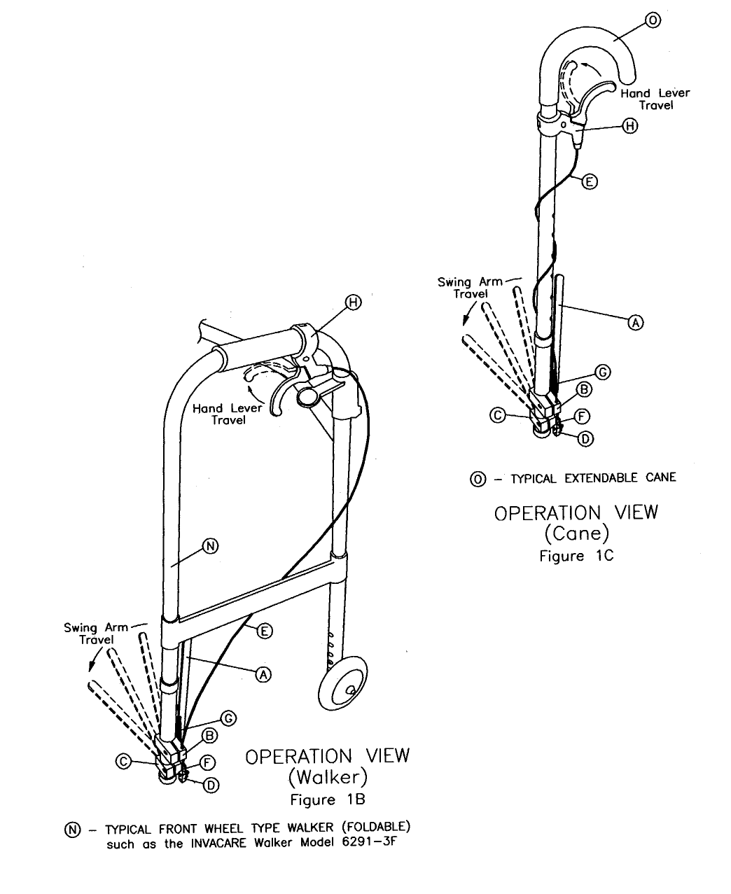

### BRIEF DESCRIPTION OF PHOTOS

Photo 1—Complete assembly on walker

Photo 2—“Step-over aid” in descended position

Photo 3—“Step-over aid” in vertical position

Photo 4—Side view of clamp assemblies

### DETAILED DESCRIPTION

Overview

The “Parkinson's Clamp-On Hand-Operated Walker Aid” is a device mounted on a walker (or cane) which is operated by lightly squeezing hand lever “H” to lower the Swing Arm “A” using a flexible cable and housing, to be used as a “step-over aid” for a person inflicted with a type of Parkinson's disease who freezes while walking. This “step-over aid” is only applied when required since it is hand operated, and will not inadvertently lower when using the walker (or cane) for stability. The Swing Arm “A” automatically returns to the upright position when the hand lever “H” is released.

In-Depth

Although this “Parkinson's Clamp-On Hand-Operated Walker Aid” can be installed and used on either a cane or walker, the following “in-Depth” description describes a typical representation of an installation on a walker, and therefore does not conclude that the following fabricated parts are precisely as stated, but only used as a reference for proper operation. When installing on a cane, substitute Walker “N” for Cane “O.

The “Parkinson's Clamp-On Hand-Operated Walker Aid” is operated by lightly squeezing Hand Lever “H”. Hand Lever “H” is mounted towards the front of the Walker “N” on a side handle bar in a position that enables the operator to easily grip the Hand Lever “H” while holding the handle bar. Hand Lever “H” has an approximate ¾-inch pull on the Flexible Steel Cable “F” which is guided in the flexible rubber-coated steel cable housing “E”. Cable housing “E” is locked in place at both ends between Hand Lever “H” and the fabricated Upper Cable Support Clamp “B”.

The Upper Cable Support Clamp “B” and fabricated Lower Rod Pivot Clamp “C” are installed on the rear leg of the Walker “N” by first removing the rubber gripper foot at the bottom of the leg, sliding both the Upper Cable Support Clamp “B” (first) and Lower Rod Pivot Clamp “C” (second) onto the leg with the head of both Allen-Head Bolts “L” facing the rear outside of the Walker “N”, then re-inserting the rubber gripper foot on the bottom of the leg of Walker “N”.

The Upper Cable Support Clamp “B” is locked in place on the leg of Walker “N” by tightening the Allen-Head Bolt “L” so that the long side of Upper Cable Support Clamp “B” is parallel with the front of the Walker “N”, and the bottom edge of Upper Cable Support Clamp “B” is about 4 inches from the bottom of the leg of Walker “N”.

Pan Head Screw “N” locks the lower end of Flexible Steel Cable “F” into the fabricated Cable Clamp and Pivot “D”. The Cable Clamp and Pivot “D” is mounted to and pivots on the end of fabricated Swing Arm “A” using an Allen Head Bolt “I”.

Swing Arm “A” pivots on the Lower Rod Pivot Clamp “C” using an Allen Head Bolt “I” at ½-inch center-to-center from the pivot hole of Cable Clamp and Pivot “D”. This creates an approximate ⅝-inch travel on Swing Arm “A” at the Cable Clamp and Pivot point in order to rotate the Swing Arm the required 90-degrees travel between the floor and the side of Walker “N”. This ⅝-inch travel falls within the limits of the Flexible Steel Cable “F” maximum ¾-inch travel (limited by Hand Lever “H”).

The Lower Rod Pivot Clamp “C” is locked in place on the leg of Walker “N” by tightening Allen-Head Bolt “L” so that the long side of Lower Rod Pivot Clamp “C” is parallel with the front of the Walker “N” and the height adjusted so that the Swing Arm “A” lays flat on a carpeted floor when in the down position. The Upper Cable Support Clamp “B” can be readjusted after locking down the Lower Rod Pivot Clamp “C” to apply the correct travel on Swing Arm “A”.

When the Hand Lever “H” is released, Swing Arm “A” is automatically returned to the upright position via the Pull Spring “G”. The Pull Spring “G” is attached at both ends between the spring hole in Swing Arm “A” and an appropriate height adjustment hole in Walker “N”. The Pull Spring “G” tension is adjusted (using the Walker “N” height adjustment holes) so that the Swing Arm “A” has just enough spring force to return to the upright position when Hand Lever “H” is released. When properly adjusted, very little pressure on Hand Lever “H” will be required to actuate (lower) Swing Arm “A”.

Allen-Head Bolts “I” are each locked in place on both the Lower Rod Pivot Clamp “C” and the Cable Clamp and Pivot “D” with a #10-24 hex nut “K”. The Allen-Head Bolts “I” are first tightened to lightly snug up against the Swing Arm “A”, then loosened ¼-turn. The #10-24 hex nuts “K” are then tightened against the Lower Rod Pivot Clamp “C” and the Cable Clamp and Pivot “D” to lock the Allen-Head Bolts “I” securely in place. This enables the Swing Arm “A” to continuously move (rotate) freely in a smooth straight plane.

Swing Arm “A” can be made more visible by painting the top surface (with Swing Arm “A” in the down position) a bright florescent color such as florescent orange and/or iridescent (glow-in-the-dark).

Swing Arm “A” is designed so as to not interfere with the operator when it is in the upright position. The Lower Rod Pivot Clamp “C” is designed to support and pivot the Swing Arm “A” at the outside of Walker “N” to minimize interference. When in the upright position, Swing Arm “A”rests flat against the sidewall of the Walker “N”.

Because the Lower Rod Pivot Clamp “C” pivots the Swing Arm “A” on the outside of the walker or cane, the entire length of Swing Arm “A” rests firmly on the floor when in the down position. This aids in preventing any injuries while stepping over or onto Swing Arm “A”, and prevents Swing Arm “A” from bending if stepped upon.

Because of the clamping method, the Upper Cable Support Clamp “B” and Lower Rod Pivot Clamp “C” are easily adjustable to position the Swing Arm “A” at the correct point so that it lays flat on the floor, and so that the Flexible Steel Cable “F” is at the right tension. One Allen-Head Bolt “L” is tightened to lock each clamp firmly in place.

This entire “Parkinson's Clamp-On Hand-Operated Walker Aid” kit can be removed at a later date with no damage or revisions to the walker (or cane).

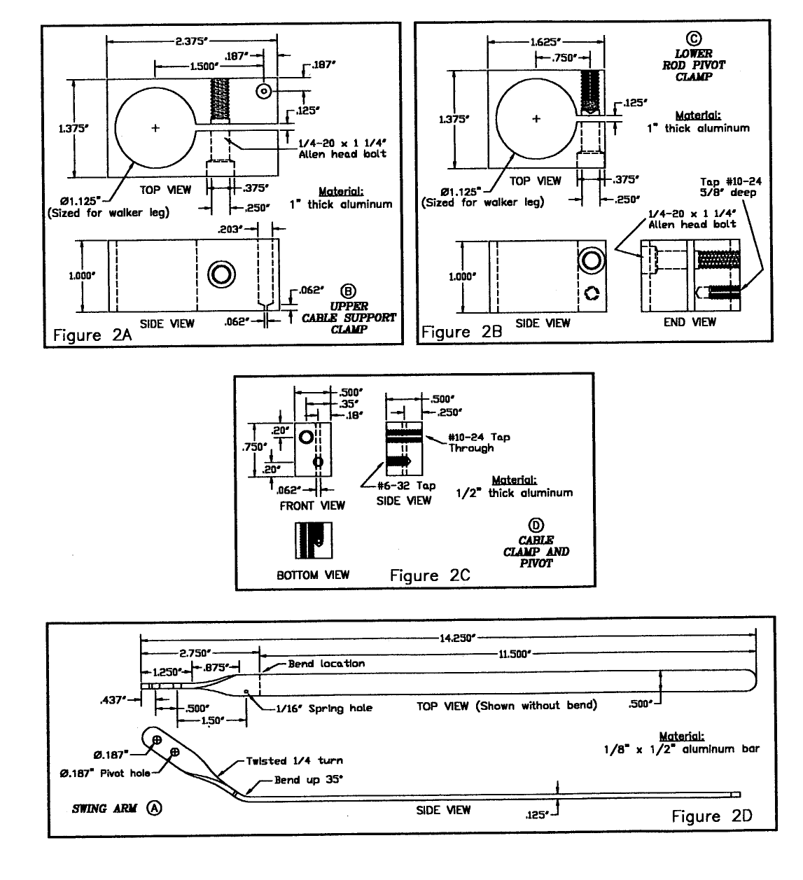

The length and weight of the Swing Arm “A”, Upper Cable Support Clamp “B” and Lower Rod Pivot Clamp “C”, location of the pivot points, and the tension of Pull Spring “G” are all important factors that make this invention practical for people with this type of Parkinson's disease. The Hand Lever “H” must actuate easily and the Swing Arm “A” must rotate a full 90-degrees and still return completely upright. Dimensions for the Swing Arm “A”, Upper Cable Support Clamp “B”, Lower Rod Pivot Clamp “C”, and Cable Clamp and Pivot “D” are specified in FIGS. 2A through 2D.

What I claim as my invention is:

1. A Parkinson's walking aid “step-over” device, which descends to the horizontal position to floor (ground) level by using and lightly squeezing a hand lever mounted on a walker or cane, and
The “step-over device” is connected to and controlled with a flexible cable and housing to said hand lever, and
The “step-over device” is automatically returned to the vertical position parallel and along side the leg of said walker or cane using a pull-spring when said hand lever is released.

2. A walking aid “step-over” device according to claim 1, wherein as an add-on and removable kit for a walker or cane, wherein the device parts clamp around said walker or cane, with no damage to said walker or cane.

3. A walking aid “step-over” device according to claim 1, wherein the device parts are so designed so as to allow said hand lever to be mounted on the hand rail at a comfortable position of said walker, forward of said “step-over aid” which is mounted at the rear of said walker, to allow the operator to comfortably squeeze said hand lever while stepping over said “step-over” aid without loosing balance.

4. A walking aid “step-over” device according to claim 1, wherein the device parts are so designed so as to not interfere with the operator when the “step-over aid” is in the returned (vertical) position.

5. A walking aid “step-over” device according to claim 1, wherein the device parts are so designed and adjustable so, when in the descended horizontal position, the “step-over aid” lays flat on the floor (ground) across the entire operator's path to prevent tripping.

6. A walking aid “step-over” device according to claim 1, wherein the device parts are so designed so as to not interfere with a foldable and/or an adjustable height walker or cane.

7. A walking aid “step-over” device according to claim 1, wherein the device parts are so designed so as to allow said pull-spring to be adjustable for proper hand lever tension.
